(19) United States
(12) Patent Application Publication
(10) Pub. No.: US 2025/0158815 A1
(43) Pub. Date: May 15, 2025

(54) Prioritized Rekeying of Security Associations

(71) Applicant: Telefonaktiebolaget LM Ericsson (publ), Stockholm (SE)

(72) Inventors: Daiying Liu, Beijing (CN); Congjie Zhang, Beijing (CN); Daniel Migault, Montreal (CA)

(21) Appl. No.: 18/695,171

(22) PCT Filed: Oct. 12, 2021
(86) PCT No.: PCT/CN2021/123230

§ 371 Date: Mar. 25, 2024

(51) Int. Cl. H04L 9/08

(52) U.S. Cl. CPC H04L 9/0891

(57) ABSTRACT

Embodiments include methods for a first node to manage rekeying of a security association (SA) between the first node and a second node in a communication network. Such methods include sending to the second node a request indicating a rekey priority of the first node, and receiving from the second node a response indicating a rekey priority of the second node. Such methods also include selectively initiating rekeying of the SA between the first node and the second node based on the request and the response. Other embodiments include complementary methods for the second node, as well as nodes (e.g., hosts, gateways, UEs, base stations, servers, etc.) configured to perform such methods.

### TECHNICAL FIELD

The present disclosure relates generally to the field of communication networks, such as the Internet, and more specifically to maintaining security associations (SAs) that facilitate secure Internet Protocol (IP) communications between two peer nodes.

### INTRODUCTION

In general, communication protocols used in current communication networks can be segmented into “layers”. For example, the International Organization for Standardization (ISO) developed the seven-layer Open Systems Interconnection (OSI) Reference Model in the early 1980's. From the highest “Application” layer to the lowest “Physical” layer, each layer represents a subset of operations common to various types of data transfers among cooperating networks.

Another model used for most current Internet communications is four-layer “TCP/IP model”, which consists of four layers. The highest “Application” layer roughly corresponds to the highest three layers of the OSI model. In order, the next lower “Transport” and “Network” layers correspond to OSI layers with the same names, while the lowest “Network Interface” layer corresponds to the lowest two layers of the OSI reference model. The name “TCP/IP model” comes from the Transport Control Protocol (TCP) often used in the Transport layer and the Internet Protocol (IP) commonly used in the Network layer.

At a high level, IP carries packet) based on routing functionality that enables inter-networking between different networks-a foundation of the Internet. More specifically, IP delivers packets from a source host to a destination host based on source and destination IP addresses in the packets themselves. Even so, IP provides only “best-effort delivery” and is unreliable due to various fault conditions that may occur. Because each packet is routed independently and the network maintains no state based on the path of prior packets, different packets may be routed to the same destination via different paths, resulting in out-of-order delivery to the receiver.

IP layer communications are also fundamentally insecure. However, Internet Protocol Security (IPsec) is a set of secure IP-layer protocols that authenticate and encrypt packets of data (or “IP datagrams”) to provide secure communication between hosts, between network gateways, or between a host and a gateway. For example, IPSec can be used in virtual private networks (VPNs).

More specifically, IPSec provides confidentiality, data integrity, access control, and data source authentication to IP datagrams. These services are provided by maintaining shared state between the source and the sink of an IP datagram. This state defines, among other things, the specific services provided to the datagram, which cryptographic algorithms will be used to provide the services, and the keys used as input to the cryptographic algorithms. The protocol used to dynamically establish and maintain this shared state is called Internet Key Exchange (IKE), which is specified in RFC 7296 published by the Internet Engineering Task Force (IETF).

IKE performs mutual authentication between two peers and establishes an IKE Security Association (SA) that includes shared secret information that can be used to efficiently establish other SAs for Encapsulating Security Payload (ESP) or Authentication Header (AH) and a set of cryptographic algorithms to be used by the SAs to protect the traffic that they carry. IKE can also negotiate use of IP Compression (IPComp) in connection with an ESP or AH SA. The SAs for ESP or AH that can be set up through that IKE SA are referred to as “Child SAs”.

Each IKE exchange includes a request/response pair of messages. The initial exchange (IKE_SA_INIT) negotiates cryptographic algorithms, exchanges nonces, and does a Diffie-Hellman exchange. The second exchange (IKE_AUTH) authenticates the previous messages, exchanges identities and certificates, and establishes the first Child SA. A CREATE_CHILD_SA exchange is used to create new Child SAs as needed. All messages following the IKE_SA_INIT exchange are encrypted and integrity protected (except headers) using the cryptographic algorithms and keys negotiated in the IKE_SA_INIT exchange.

The various SAs include secret keys that should be used only for a limited time and to protect only a limited amount of data. An SA must not be used after its lifetime expires (i.e., due to time and/or data limits). If there is ongoing demand, a new SA may be established between the peers; this process is often referred to as “rekeying”. The CREATE_CHILD_SA exchange is also used to rekey both IKE SAs and Child SAs as needed.

### SUMMARY

However, there can be various problems, issues, and/or difficulties with rekeying IKE SAs or child SAs, particularly when the peers (or nodes) sharing the SAs use the same or substantially similar lifetime policies for the SAs. This can cause rekeying to be initiated concurrently and/or nearly simultaneously by both nodes, resulting in redundant SAs between the two nodes.

Accordingly, embodiments of the present disclosure address these and other problems, issues, and/or difficulties by providing prioritized rekeying of SAs, thereby facilitating secure communications based on IPSec or similar protocols.

Some embodiments of the present disclosure include methods (e.g., procedures) for a first node to manage rekeying of a security association (SA) between the first node and a second node in a communication network.

These exemplary methods can include sending to the second node a request indicating a rekey priority of the first node. These exemplary methods can also include receiving from the second node a response indicating a rekey priority of the second node. These exemplary methods can also include selectively initiating rekeying of the SA between the first node and the second node based on the request and the response.

In some embodiments, the request and the response comprise one of the following: an IKE_INIT exchange, an IKE_AUTH exchange, or a CREATE_CHILD_SA exchange. In some embodiments, the SA is one of the following: an IKE SA, or a child SA.

In some embodiments, the request and the response include a message type field that can have any one of a plurality of different values, including a first message type value indicating that the sending node (e.g., first node sending request, second node sending response) supports rekey priority. In some of these embodiments, when the request includes a message type field that does not have the first message type value, the response also includes a message type field that does not have the first message type value.

In some embodiments, when the request or the response includes a message type field having the first message type value, the request or the response also includes a rekey priority indicator that can have any one of a plurality of different values. In some embodiments, when present, the message type field and the rekey priority indicator are included in a Notify message, which is included in an encrypted payload of the request or the response.

In some embodiments, the plurality of different values of the rekey priority indicator include a plurality of first values that indicate a respective plurality of different rekey priorities configured in the sending node.

In some of these embodiments, these exemplary methods can also include randomly selecting the rekey priority of the first node based on determining that rekeying is enabled but rekey priority is not configured in the first node. In such case, the request can include one of the first values that indicates the randomly selected rekey priority of the first node.

In some of these embodiments, when the request and the response include respective rekey priority indicators with any of the first values, selectively initiating the rekeying of the SA can include the following operations: initiating the rekeying of the SA when the rekey priority of the first node is greater than or equal to the rekey priority of the second node; and refraining from initiating the rekeying of the SA when the rekey priority of the first node is less than the rekey priority of the second node. In some of these embodiments, these exemplary methods can also include completing a rekeying of the SA that was initiated by the second node. This can be done, for example, when the request and the response include respective rekey priority indicators with any of the first values and the rekey priority of the first node is less than the rekey priority of the second node.

In some embodiments, the plurality of different values of the rekey priority indicator include a second value that indicates rekeying is disabled in the sending node. In some variants, the second value can be a particular one of the first values that also indicates a lowest rekey priority. In such embodiments, selectively initiating the rekeying of the can include initiating the rekeying of the SA when a rekey priority indicator having the second value is present in the response and rekeying is enabled in the first node.

Other embodiments include methods (e.g., procedures) for a second node to manage rekeying of a security association (SA) between the second node and a first node in a communication network. In general, these exemplary methods can be complementary the methods performed by the first node, as summarized above.

These exemplary methods can include receiving from the first node a request indicating a rekey priority of the first node. These exemplary methods can also include sending to the first node a response indicating a rekey priority of the second node. These exemplary methods can also include selectively initiating rekeying of the SA between the first node and the second node based on the request and the response.

In some embodiments, the request and the response comprise one of the following: an IKE_INIT exchange, an IKE_AUTH exchange, or a CREATE_CHILD_SA exchange. In some embodiments, the SA is one of the following: an IKE SA, or a child SA.

In some embodiments, the request and the response include a message type field that can have any one of a plurality of different values, including a first message type value indicating that the sending node (e.g., first node sending request, second node sending response) supports rekey priority. In some of these embodiments, when the request includes a message type field that does not have the first message type value, the response also includes a message type field that does not have the first message type value.

In some embodiments, when the request or the response includes a message type field having the first message type value, the request or the response also includes a rekey priority indicator that can have any one of a plurality of different values. In some embodiments, when present, the message type field and the rekey priority indicator are included in a Notify message, which is included in an encrypted payload of the request or the response.

In some embodiments, the plurality of different values of the rekey priority indicator include a plurality of first values that indicate a respective plurality of different rekey priorities configured in the sending node.

In some of these embodiments, these exemplary methods can also include randomly selecting the rekey priority of the second node based on determining that rekeying is enabled but rekey priority is not configured in the second node. In such case, the response can include one of the first values that indicates the randomly selected rekey priority of the second node.

In some of these embodiments, when the request and the response include respective rekey priority indicators with any of the first values, selectively initiating the rekeying of the SA can include the following operations: initiating the rekeying of the SA when the rekey priority of the second node is greater than or equal to the rekey priority of the first node; and refraining from initiating the rekeying of the SA when the rekey priority of the second node is less than the rekey priority of the first node.

In some of these embodiments, these exemplary methods can also include completing a rekeying of the SA that was initiated by the first node. This can be done, for example, when the request and the response include respective rekey priority indicators with any of the first values and the rekey priority of the second node is less than the rekey priority of the first node.

In some embodiments, the plurality of different values of the rekey priority indicator include a second value that indicates rekeying is disabled in the sending node. In some variants, the second value can be a particular one of the first values that also indicates a lowest rekey priority. In such embodiments, selectively initiating the rekeying of the SA can include initiating the rekeying of the SA when a rekey priority indicator having the second value is present in the request and rekeying is enabled in the second node.

Other embodiments include nodes (e.g., host, gateway, UE, base station, server, etc.) that are configured to perform the operations corresponding to any of the exemplary methods described herein. Other embodiments include non-transitory, computer-readable media storing computer-executable instructions that, when executed by processing circuitry, configure such nodes to perform operations corresponding to any of the exemplary methods described herein.

These and other embodiments described herein can restrict rekeying to be initiated by only one of two nodes that share a SA (e.g., in IPSec communications). As such, embodiments can reduce, minimize, or even eliminate the problems associated with redundant SAs, thereby avoiding the negative impacts to node resources (e.g., processing, memory, communication, etc.) as well as communication resources (e.g., transmission, routing, etc.) between nodes. Embodiments are also backward compatible with legacy nodes that do not support these novel mechanisms, thereby avoiding interoperability problems. At a higher level, embodiments facilitate secure communication between two nodes based on maintaining up to date SAs without excess use of resources.

These and other objects, features, and advantages of the present disclosure will become apparent upon reading the following Detailed Description in view of the Drawings briefly described below.

### BRIEF DESCRIPTION OF THE DRAWINGS

FIG. 1 shows an exemplary IKE_INIT exchange between an initiator and a responder.

FIG. 2 shows an exemplary IKE_AUTH exchange between an initiator and a responder.

FIG. 3, which includes FIGS. 3A-C, shows three exemplary CREATE_CHILD_SA exchanges between an initiator and a responder.

FIG. 4 shows an exemplary IKE_AUTH exchange between a first node and a second node, according to various embodiments of the present disclosure.

FIG. 5 shows an exemplary CREATE_CHILD_SA exchange between a first node and a second node for rekeying an existing Child SA between the first and second nodes, according to various embodiments of the present disclosure.

FIGS. 6A-6B show a data structure for an exemplary Notify message according to various embodiments of the present disclosure.

FIG. 7 shows a flow diagram of an exemplary procedure for a first node to create and send a request message, according to various embodiments of the present disclosure.

FIG. 8 shows a flow diagram of an exemplary procedure for a second node to receive and process a request message, according to various embodiments of the present disclosure.

FIG. 9 shows a flow diagram of another exemplary procedure for a second node to receive and process a request message, according to various embodiments of the present disclosure.

FIG. 10 shows a flow diagram of an exemplary procedure for a first node to receive and process a response message, according to various embodiments of the present disclosure.

FIG. 11 illustrates an exemplary method (e.g., procedure) for a first node, according to various embodiments of the present disclosure.

FIG. 12 illustrates an exemplary method (e.g., procedure) for a second node, according to various embodiments of the present disclosure.

FIGS. 13-14 shows two exemplary communication networks in which various embodiments can be implemented.

FIGS. 15-17 show a user equipment (UE), a network node, and a host computing system, respectively, according to various embodiments of the present disclosure.

FIG. 18 is a block diagram of a virtualization environment in which various embodiments of the present disclosure may be virtualized.

FIG. 19 illustrates communication between a host computing system, a network node, and a UE via multiple connections, according to various embodiments of the present disclosure.

### DETAILED DESCRIPTION

Embodiments briefly summarized above will now be described more fully with reference to the accompanying drawings. These descriptions are provided by way of example to explain the subject matter to those skilled in the art and should not be construed as limiting the scope of the subject matter to only the embodiments described herein. More specifically, examples are provided below that illustrate the operation of various embodiments according to the advantages discussed above.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods and/or procedures disclosed herein do not have to be performed in the exact order disclosed, unless a step is explicitly described as following or preceding another step and/or where it is implicit that a step must follow or precede another step. Any feature of any of the embodiments disclosed herein can be applied to any other embodiment, wherever appropriate. Likewise, any advantage of any of the embodiments can apply to any other embodiments, and vice versa.

As briefly mentioned above, there can be various problems, issues, and/or difficulties with rekeying IKE SAs or child SAs, particularly when the peers (or nodes) sharing the SAs use the same or substantially similar lifetime policies for the SAs. This can cause rekeying to be initiated concurrently and/or nearly simultaneously by both nodes, resulting in redundant SAs between the two nodes. This is discussed in more detail after the following description of IKE.

As used herein, the term “node” can refer to any type of device or apparatus of that is capable of operating in and/or communicating via a wired or wireless network, including but not limited to access nodes (e.g., radio access nodes such as base stations), core network nodes, servers, gateways, user equipment (UEs), etc. Examples of various nodes are described below with reference to various figures.

As mentioned above, each IKE exchange includes a request/response pair of messages. Every IKE message contains a Message ID as part of its fixed header. This Message ID is used to match up requests and responses, and to identify retransmissions of messages. The listing below defines some abbreviations used for various payloads or headers contained in IKE messages.

| Notation | Payload |
|---|---|
| AUTH | Authentication |
| CERT | Certificate |
| CERTREQ | Certificate Request |
| CP | Configuration |
| D | Delete |
| EAP | Extensible Authentication |
| HDR | IKE header (not a payload) |
| IDi | Identification - Initiator |
| IDr | Identification - Responder |
| KE | Key Exchange |
| Ni, Nr | Nonce - Initiator |
| Nr | Nonce - Responder |
| N | Notify |
| SA | Security Association |
| SK {x} | “x” is encrypted and authenticated |
| TSI | Traffic Selector - Initiator |
| TSr | Traffic Selector - Responder |
| V | Vendor ID |

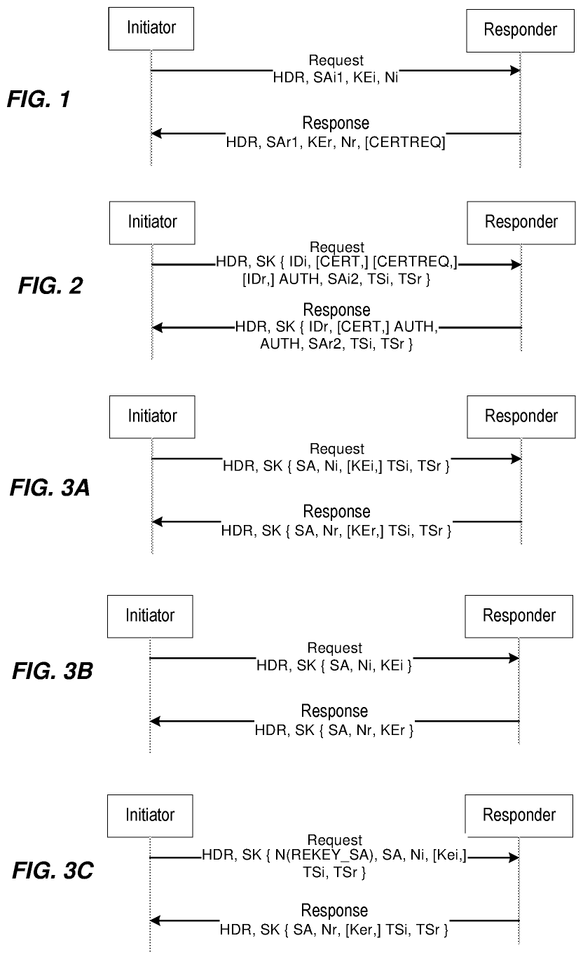

The initial exchange (IKE_SA_INIT) negotiates cryptographic algorithms, exchanges nonces, and does a Diffie-Hellman exchange. FIG. 1 shows an exemplary IKE_INIT exchange between an initiator and a responder. Initially, the initiator sends a request with a HDR that contains Security Parameter Indexes (SPIs), version numbers, Exchange Type, Message ID, and various flags. The SAi1 payload indicates the cryptographic algorithms the initiator supports for the IKE SA. The KE payload includes the initiator's (non-secret) Diffie-Hellman value and Ni is the initiator's nonce (an arbitrary number used only once).

Upon receiving the request, the responder chooses a cryptographic suite from the initiator's offered choices and indicates the choice in the SAr1 payload. The responder includes its own (non-secret) Diffie-Hellman value in the KEr payload and includes a nonce in the Nr payload. At this point, each node can generate a SKEYSEED from which all keys can be derived for the IKE SA.

The messages that follow are encrypted and integrity protected in their entirety, except for message headers. The keys used for the encryption and integrity protection are derived from SKEYSEED and are known as SK_e (encryption) and SK_a (authentication or integrity protection). An SK_e/SK_a pair is computed for each direction. In addition to SK_e and SK_a derived for protection of the IKE SA, another quantity SK_d is derived and used for derivation of further keying material for Child SAs.

The second exchange (IKE_AUTH) authenticates the previous messages, exchanges identities and certificates, and establishes the first Child SA. FIG. 2 shows an exemplary IKE_AUTH exchange between an initiator and a responder. Initially, the initiator sends a request with a HDR that contains Security Parameter Indexes (SPIs), version numbers, Exchange Type, Message ID, and various flags. The payload of the request (i.e., within SK{ }) is encrypted and integrity protected. In this payload, the initiator asserts its identity with IDi, proves knowledge of the secret corresponding to IDi, and integrity protects the contents of the first message using the AUTH payload. The initiator optionally includes its certificate(s) in CERT and/or a list of its trust anchors in CERTREQ. If any CERT payloads are included, the first certificate provided must contain the public key used to verify the AUTH payload. The initiator begins negotiation of a Child SA using the SAi2 payload.

The optional payload IDr enables the initiator to specify to which of the responder's identities it wants to talk. This is useful when the node on which the responder is running is hosting multiple identities at the same IP address. If the IDr proposed by the initiator is not acceptable to the responder, the responder might use some other IDr to finish the exchange. If the initiator then does not accept the fact that responder used an IDr different than the one that was requested, the initiator can close the SA after noticing that fact.

The Traffic Selectors (TSi and TSr) appear in each message of the IKE_AUTH exchange. The pair specify selection criteria for packets that will be forwarded over the newly set up SA. This can serve as a consistency check for SPDs in some scenarios while guiding the dynamic update of the SPD in other scenarios. Each TS payload contains one or more Traffic Selectors, each of which consists of an address range (IPv4 or IPv6), a port range, and an IP protocol ID.

The responder sends a response with a HDR that contains SPIs, version numbers, Exchange Type, Message ID, and various flags. The payload of the response (i.e., within SK{ }) is encrypted and integrity protected. In the response, the responder asserts its identity with the IDr payload, optionally includes one or more certificates, and authenticates its identity and protects the integrity of the second message with the AUTH payload. The responder completes negotiation of a Child SA by choosing a cryptographic suite from the initiator's offered choices in SAi2 and indicates the choice in the SAr2 payload.

A CREATE_CHILD_SA exchange is used to create new Child SAs as needed, and to rekey both IKE SAs and Child SAs as needed. An SA is rekeyed by creating a new SA and then deleting the old one. Note that a CREATE_CHILD_SA exchange can be initiated by either node (or peer) sharing the IKE SA after the initial exchanges are completed.

FIG. 3A shows an exemplary CREATE_CHILD_SA exchange between an initiator and a responder for creating a new Child SA. The initiator in FIG. 3A may be the initiator or the responder in FIGS. 1-2, and vice versa.

Initially, the initiator sends a request with a HDR that contains Security Parameter Indexes (SPIs), version numbers, Exchange Type, Message ID, and various flags. The payload of the request (i.e., within SK{ }) is encrypted and integrity protected. In this payload, the initiator sends SA offer(s) in the SA payload, a nonce in the Ni payload, (optionally) a Diffie-Hellman value in the KEi payload, and Traffic Selectors for the proposed new Child SA in the TSi and TSr payloads.

When included, the KEi payload is part of an additional Diffie-Hellman exchange to enable stronger guarantees of forward secrecy for the Child SA. The keying material for the Child SA is a function of SK_d established during the establishment of the IKE SA, the nonces exchanged during the CREATE_CHILD_SA exchange, and the Diffie-Hellman value (if KE payloads are included in the CREATE_CHILD_SA exchange).

The responder sends a response with a HDR that contains Security Parameter Indexes (SPIs), version numbers, Exchange Type, Message ID, and various flags. The payload of the response (i.e., within SK{ }) is encrypted and integrity protected. The responder includes the accepted offer in an SA payload, a nonce in the Nr payload, and optionally a Diffie-Hellman value in the KEr payload. The KEr payload is included when KEi was included in the requests and the selected cryptographic suite includes that group. The Traffic Selectors for traffic to be sent on that SA are specified in the TS payloads in the response, which may be a subset of what the initiator of the Child SA proposed in the request.

FIG. 3B shows an exemplary CREATE_CHILD_SA exchange between an initiator and a responder for rekeying an existing IKE SA. The initiator in FIG. 3B may be the initiator or the responder in FIGS. 1-2, and vice versa.

Initially, the initiator sends a request with a HDR that contains Security Parameter Indexes (SPIs), version numbers, Exchange Type, Message ID, and various flags. The payload of the request (i.e., within SK{ }) is encrypted and integrity protected. In this payload, the initiator includes SA offer(s) in the SA payload, a nonce in the Ni payload, and a Diffie-Hellman value in the KEi payload, which must be included. A new initiator SPI is supplied in the SPI field of the SA payload.

The responder sends a response with a HDR that contains Security Parameter Indexes (SPIs), version numbers, Exchange Type, Message ID, and various flags. The payload of the response (i.e., within SK{ }) is encrypted and integrity protected. The responder includes the accepted offer in the SA payload, a nonce in the Nr payload, and a Diffie-Hellman value in the KEr payload if the selected cryptographic suite includes that group. A new responder SPI is supplied in the SPI field of the SA payload.

FIG. 3C shows an exemplary CREATE_CHILD_SA exchange between an initiator and a responder for rekeying an existing Child SA. The initiator in FIG. 3C may be the initiator or the responder in FIGS. 1-2, and vice versa.

Initially, the initiator sends a request with a HDR that contains Security Parameter Indexes (SPIs), version numbers, Exchange Type, Message ID, and various flags. The payload of the request (i.e., within SK{ }) is encrypted and integrity protected. In this payload, the initiator includes SA offer(s) in the SA payload, a nonce in the Ni payload, optionally a Diffie-Hellman value in the KEi payload, and the proposed Traffic Selectors for the proposed Child SA in the TSi and TSr payloads.

The initiator also includes a Notify message with REKEY_SA message type in the encrypted and integrity protected request payload. The REKEY_SA notification MUST be included in a CREATE_CHILD_SA exchange when replacing an existing ESP SA or AH SA. The SA being rekeyed is identified by the SPI field in the Notify payload; this is the SPI the exchange initiator would expect in inbound ESP or AH packets.

The responder sends a response with a HDR that contains Security Parameter Indexes (SPIs), version numbers, Exchange Type, Message ID, and various flags. The payload of the response (i.e., within SK{ }) is encrypted and integrity protected. The responder includes the accepted offer in the SA payload, a nonce in the Nr payload, and a Diffie-Hellman value in the KEr payload if KEi was included in the request and the selected cryptographic suite includes that group. The Traffic Selectors for traffic to be sent on that SA are specified in the TS payloads in the response, which may be a subset of what the initiator of the Child SA proposed.

If the two nodes sharing an SA use the same or substantially similar lifetime policies for the SA, it is possible that rekeying will be initiated concurrently and/or nearly simultaneously by both nodes. One way to reduce the probability of this happening is to delay the timing of rekeying requests by a random amount of time after the need for rekeying is noticed. Even with this technique, there is still the possibility that rekeying will be initiated concurrently and/or nearly simultaneously by both nodes.

This can result in redundant SAs between the two nodes, which is undesirable. One way to address this problem is based on nonce values. If redundant SAs are created, the SA with the lowest of the four nonces used in the two exchanges should be closed by the node that created it. “Lowest” can mean an octet-by-octet comparison, e.g., start by comparing the first octet; if they're equal, move to the next octet, and so on. If you reach the end of one nonce, that nonce is the lower one. The node that initiated the surviving rekeyed SA should delete the replaced SA after the new one is established.

Even if redundant SAs can be removed by nonce comparison, their creation and existence prior to removal can still be problematic. Consider the following example. Assume that first and second nodes have an existing Child SA pair with SPIs (SPIa1, SPIb1), and both nodes start rekeying the Child SA at (substantially) the same time. Acting as initiators, both nodes send requests as shown in FIG. 3C. Upon receiving the request from the peer node, each node becomes aware that there is a simultaneous rekeying happening, i.e., two exchanges occurring in parallel. However, each node is not yet aware which of which exchange will have the lowest nonce, so it will just note the situation and respond as illustrated in FIG. 3C. I

At this point, there are three Child SA pairs between the first and second nodes: the old one and two new ones. Even if the nodes delete the old SA the two redundant child SAs still exist. If only one IKE session and one pair of redundant child SAs are involved, the problem is not too significant. Even so, the redundancy problem is much more severe in practical deployments with hundreds of IKE sessions and thousands of Child SAs. It can lead to node system health problems because the redundant SAs occupy too many storage, computing, and/or communication resources. Additionally, negotiation of redundant SAs places tens of thousands IKE protocol packets on the Internet, which takes away from limited amounts of available transmission bandwidth. This extra IKE traffic can also break other critical protocols (e.g., routing) since IKE packets should have a very high cost-of-service (COS).

Embodiments of the present disclosure address these and other problems, issues, and/or difficulties by providing prioritized rekeying of SAs, thereby facilitating secure communications based on IPSec or similar protocols. Embodiments can avoid concurrent SA rekeying based on a novel protocol payload field and a novel rekey arbitration mechanism based on the new payload field. These mechanisms restrict rekeying to be initiated by only one of two nodes that share a SA. As such, these mechanisms can reduce, minimize, or even eliminate the problems associated with redundant SAs, thereby avoiding the negative impacts to node resources (e.g., processing, memory, communication, etc.) as well as communication resources (e.g., transmission, routing, etc.) between nodes. The mechanisms are also backward-compatible with legacy nodes that do not support them, thereby avoiding interoperability problems.

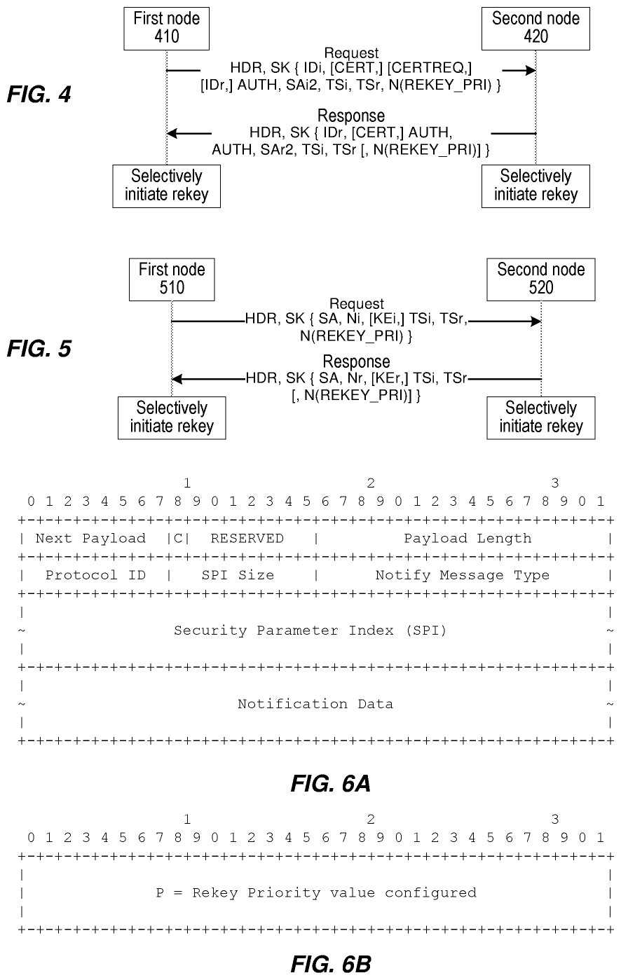

FIG. 4 shows an exemplary IKE_AUTH exchange between a first node (410) and a second node (420), according to various embodiments of the present disclosure. In the context of FIG. 4, the first node can be the initiator shown in FIG. 2, and the second node can be the responder shown in FIG. 2.

The first node initially sends a request, which can include the HDR and a payload (i.e., within SK{ }) that is encrypted and integrity protected. In addition to the request payload fields described above with reference to FIG. 2, the request payload fields in FIG. 4 can include a Notify message with a message type of “REKEY_PRI”, which can indicate that the first node supports selective rekeying based on respective priority values.

The second node then sends a response, which can include the HDR and a payload (i.e., within SK{ }) that is encrypted and integrity protected. In addition to the response payload fields described above with reference to FIG. 2, the response payload fields in FIG. 4 can optionally include a Notify message with a message type of “REKEY_PRI”, which can indicate that the second node supports selective rekeying based on respective priority values. As explained in more detail below, the Notify message is not included when the second node does not recognize the Notify message with message type of “REKEY_PRI” in the request.

After this exchange, the first and second nodes can selectively initiate rekeying based on the contents of the respective messages, as explained in more detail below.

FIG. 5 shows an exemplary CREATE_CHILD_SA exchange between a first node (510) and a second node (520) for rekeying an existing Child SA between the first and second nodes, according to various embodiments of the present disclosure.

The first node initially sends a request, which can include the HDR and a payload (i.e., within SK{ }) that is encrypted and integrity protected. In addition to the request payload fields described above with reference to FIG. 3C, the request payload fields in FIG. 5 can include a Notify message with a message type of “REKEY_PRI”, which can indicate that the first node supports selective rekeying based on respective priority values.

The second node then sends a response, which can include the HDR and a payload (i.e., within SK{ }) that is encrypted and integrity protected. In addition to the response payload fields described above with reference to FIG. 3C, the response payload fields in FIG. 5 can optionally include a Notify message with a message type of “REKEY_PRI”, which can indicate that the second node supports selective rekeying based on respective priority values. As explained in more detail below, the Notify message is not included when the second node does not recognize the Notify message with message type of “REKEY_PRI” in the request.

After this exchange, the first and second nodes can selectively initiate rekeying based on the contents of the respective messages, as explained in more detail below.

Skilled persons will understand that techniques similar to those illustrated by FIGS. 4-5 can also be applied to an IKE_SA_INIT exchange, such as shown in FIG. 1.

FIGS. 6A-B show a data structure for an exemplary Notify message according to various embodiments of the present disclosure. In FIG. 6A, the “Notify Message Type” field contains one of a plurality of different values corresponding to different message types, such as listed below:

| Value | Notify Message Type |
|---|---|
| 16434 | PUZZLE |
| 16435 | USE_PPK |
| 16436 | PPK_IDENTITY |
| 16437 | NO_PPK_AUTH |
| 16438 | INTERMEDIATE_EXCHANGE_SUPPORTED |
| 16439 | IP4_ALLOWED |
| 16440 | IP6_ALLOWED |
| 16441 | REKEY_PRI |

Note that these message types are exemplary and non-exclusive. Since “REKEY_PRI” is the only one of the above-listed message types that is relevant to the present discussion, description of the other message types will be omitted for brevity.

The exemplary “Notify” message in FIG. 6A also includes a “Next Payload” field, where a value N(41) indicates that this is Notify payload and the recipient should skip this payload if it does not understand the payload type code. Additionally, the exemplary “Notify” message in FIG. 6A also includes a “Protocol ID” field with value of 0 and an “SPI Size” field with value of 0, both of which indicate that this payload does not concern the SPI.

The “Notification Data” field in FIG. 6A includes data that is specific to the particular message type indicated by the “Notify Message Type” field. FIG. 6B shows the “Notification Data” field for “REKEY_PRI” message type. This data field includes an indicator of the rekey priority configured for the sending node (e.g., first node in request, second node for response). In this example the rekey priority indicator is a 32-bit (8-octet) field that can take on any one of a plurality of different values with corresponding meanings, as described in more detail below.

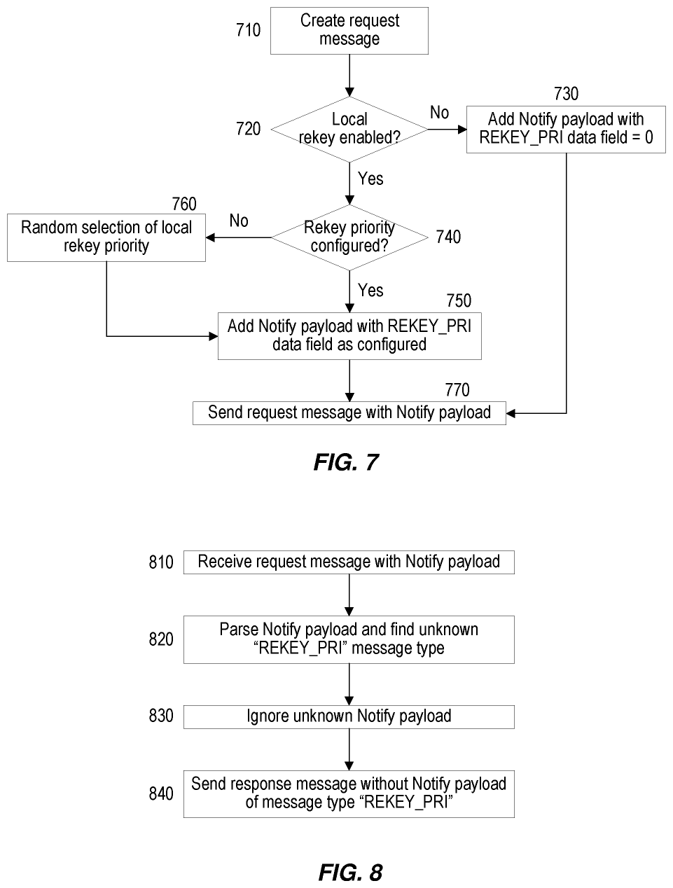

FIG. 7 shows a flow diagram of an exemplary procedure for a first node to create and send a request message, according to various embodiments of the present disclosure. For example, the request may be part of an IKE_AUTH exchange (as shown in FIG. 4) or part of an CREATE_CHILD_SA exchange (as shown in FIG. 5). Although the various operations shown in FIG. 7 are given numerical labels, these are intended to facilitate explanation rather than to require or imply a particular order of the operations, unless expressly stated to the contrary.

In block 710, the first node creates the request message, e.g., with an appropriate HDR and a Notify payload with message type “REKEY_PRI”. In block 720, the first node determines whether its local SA rekeying function is enabled. If not, the first node proceeds to block 730 where it adds to the Notify payload a data field with value set to zero (0), which indicates that the first node's SA rekeying function is disabled.

On the other hand, if the local SA rekeying function is enabled, the first node proceeds to block 740 where it determines whether local rekey priority is configured. If local rekey priority is/has been configured, the first node proceeds directly from block 740 to block 750, where it adds to the Notify payload a data field having a value corresponding to the configured rekey priority. In general, this value can be any one of the plurality of different values, each corresponding to a different rekey priority. For example, a greater value can indicate a higher rekey priority than a lesser value.

On the other hand, if local rekey priority is not configured, the first node proceeds from block 740 to block 760 where it randomly selects one of a plurality of different values, each corresponding to a different rekey priority. Put differently, when local rekey priority is not configured, the first node can randomly select a local rekey priority from among the available rekey priorities. The first node will configure and/or apply the randomly selected local rekey priority for its own use. Operation then proceeds to block 750, discussed above.

In block 770, the first node sends the request message with the Notify payload constructed in the manner described above.

FIG. 8 shows a flow diagram of an exemplary procedure for a second node to receive and process a request message, according to various embodiments of the present disclosure. For example, the request message may be part of an IKE_AUTH exchange (as shown in FIG. 4) or part of an CREATE_CHILD_SA exchange (as shown in FIG. 5). Although the various operations shown in FIG. 8 are given numerical labels, these are intended to facilitate explanation rather than to require or imply a particular order of the operations, unless expressly stated to the contrary.

In block 810, the second node receives the request message from the first node with a Notify payload. In block 820, the second node parses the request message and finds a Notify payload with message type “REKEY_PRI”. In this example, the second node does not support rekey priority and thus does not recognize this message type. Based on the other message fields, however, the second node ignores this unrecognized Notify message (block 830) and sends a response message that does not include a Notify payload with message type “REKEY_PRI”. Based on receiving this response without a Notify payload with message type “REKEY_PRI”, the first node can infer that the second node does not support rekey priority.

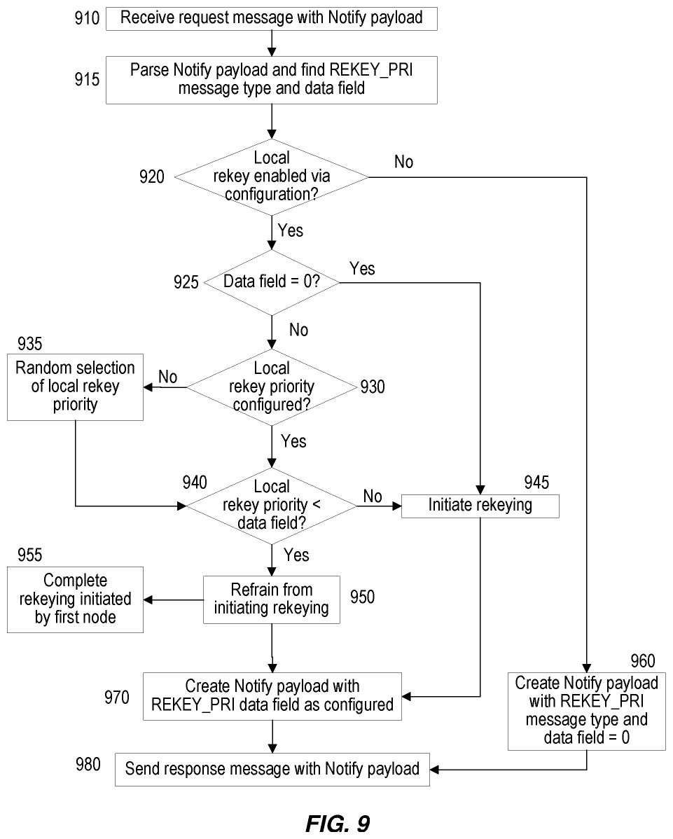

FIG. 9 shows a flow diagram of another exemplary procedure for a second node to receive and process a request message, according to various embodiments of the present disclosure. For example, the request message may be part of an IKE_AUTH exchange (as shown in FIG. 4) or part of an CREATE_CHILD_SA exchange (as shown in FIG. 5). Although the various operations shown in FIG. 9 are given numerical labels, these are intended to facilitate explanation rather than to require or imply a particular order of the operations, unless expressly stated to the contrary.

In block 910, the second node receives the request message from the first node with a Notify payload. In block 915, the second node parses the request message and finds a Notify payload with message type “REKEY_PRI” and corresponding data field. In this example, the second node supports rekey priority and thus recognizes this message type. In block 920, the second node determines if its local rekeying function is enabled (e.g., by configuration). If not, the second node proceeds to block 950 where it creates a Notify payload with “REKEY_PRI” message type and a data field with value set to zero (0), which indicates that the second node's local rekeying function is disabled. Although not shown, the second node may also perform the operations of block 955, where it completes a rekeying initiated by the first node (i.e., with higher priority).

On the other hand, if the local SA rekeying function is enabled, the first node proceeds to block 925 where it determines whether the data field in the Notify payload has a value of zero, which indicates that the first node's local rekeying function is disabled. If the data field contains zero, the second node proceeds to block 945 where it initiates rekeying of the SA and to block 970, where it creates a Notify payload with “REKEY_PRI” message type and a data field with value set to the configured rekey priority.

On the other hand, if the data field in the Notify payload does not contain zero, the second node proceeds to block 930, where it determines whether its local rekey priority is configured. If local rekey priority is not configured, the second node proceeds to block 935 where it randomly selects one of a plurality of different values, each corresponding to a different rekey priority. Put differently, when local rekey priority is not configured, the second node can randomly select a local rekey priority from among the available rekey priorities. The second node will configure and/or apply the randomly selected local rekey priority for its own use. Operation then proceeds to block 940, discussed below.

On the other hand, if local rekey priority is configured, the first node proceeds directly from block 930 to block 940, where it determines whether its local rekey priority is less than the first node's rekey priority indicated by the data field. If the second node's rekey priority is less than the first node's rekey priority, the second node proceeds to block 950 where it refrains from initiating rekeying of the SA (i.e., due to lower priority) and then to block 970, discussed above. In this case, however, the second node may also perform the operations of block 955, where it completes a rekeying initiated by the first node (i.e., with higher priority).

If the second node's rekey priority is greater than or equal to the first node's rekey priority, the second node proceeds to block 945 where it initiates rekeying of the SA and to block 970, discussed above.

In block 980, the second node sends the response message with the Notify payload constructed in the manner described above.

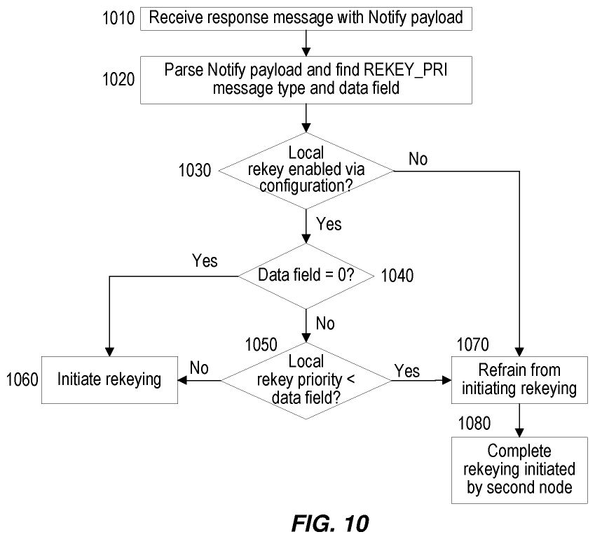

FIG. 10 shows a flow diagram of an exemplary procedure for a first node to receive and process a response message, according to various embodiments of the present disclosure. For example, the response message may be part of an IKE_AUTH exchange (as shown in FIG. 4) or part of an CREATE_CHILD_SA exchange (as shown in FIG. 5). Although the various operations shown in FIG. 10 are given numerical labels, these are intended to facilitate explanation rather than to require or imply a particular order of the operations, unless expressly stated to the contrary.

In block 1010, the first node receives the response message from the second node with a Notify payload. In block 1020, the first node parses the request message and finds a Notify payload with message type “REKEY_PRI” and corresponding data field. In this example, the first node supports rekey priority and thus recognizes this message type. In block 1030, the first node determines if its local rekeying function is enabled (e.g., by configuration). If not, the first node proceeds to block 1070 where it refrains from initiating rekeying one or more SAs between the first node and the second node. In this case, however, the first node may also perform the operations of block 1080, where it completes a rekeying initiated by the second node.

On the other hand, if the local SA rekeying function is enabled, the first node proceeds to block 1040 where it determines whether the data field in the Notify payload has a value of zero, which indicates that the second node's local rekeying function is disabled. If the data field contains zero, the first node proceeds to block 1060 where it initiates rekeying one or more SAs between the first node and the second node.

On the other hand, if the data field in the Notify payload does not contain zero, the first node proceeds to block 1050, where it determines whether its local rekey priority is less than the second node's rekey priority indicated by the data field. If the first node's rekey priority is greater than or equal to the second node's rekey priority, the first node proceeds to block 1060 where it can initiate rekeying one or more SAs between the first node and the second node. Alternately, the first node can set a flag based on the result of block 1050, and when a need for rekeying later arises, the first node can initiate the rekeying based on the flag.

If the first node's rekey priority is less than the second node's rekey priority, the first node proceeds to block 1070 where it refrains from initiating rekeying one or more SAs between the first node and the second node, e.g., in the manner described above. In this case, however, the first node may also perform the operations of block 1080, where it completes a rekeying initiated by the second node (i.e., with higher priority).

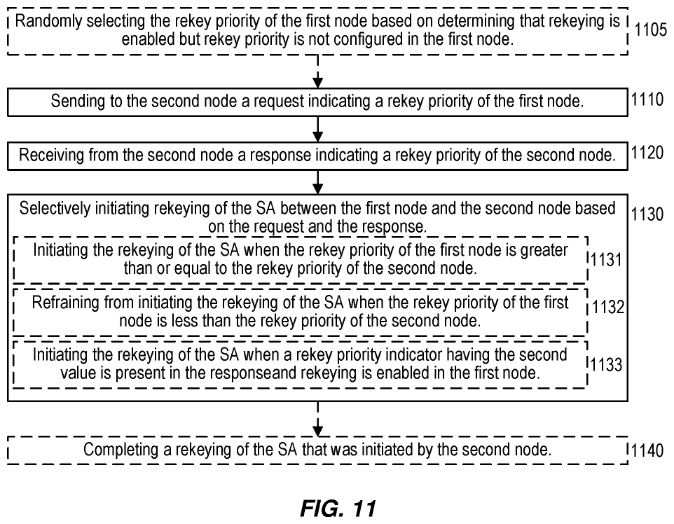

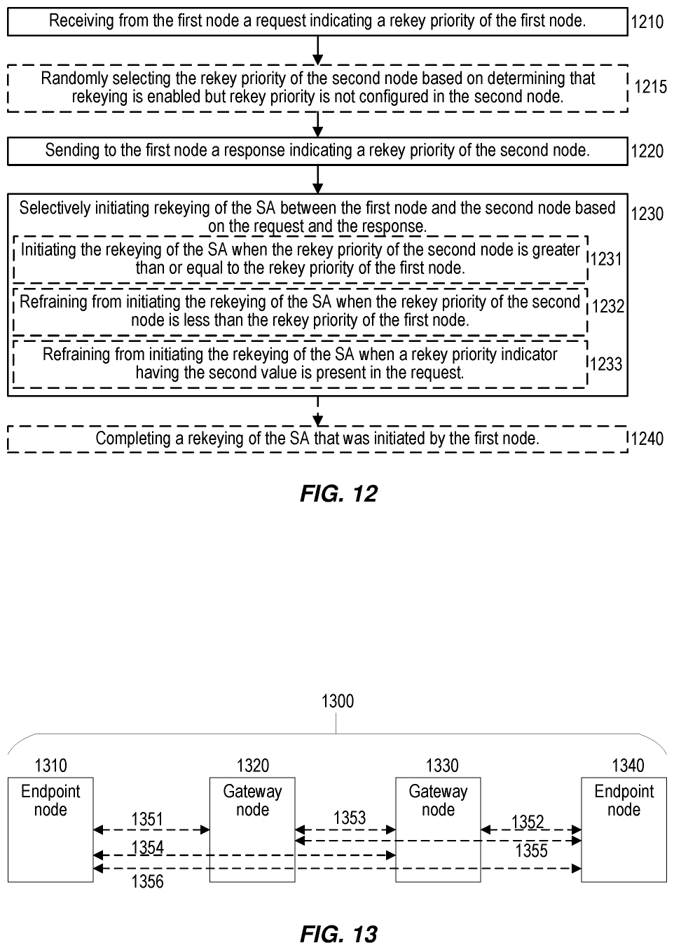

The embodiments described above can be further illustrated with reference to FIGS. 11-12, which depict exemplary methods (e.g., procedures) performed by a first node and a second node, respectively. Put differently, various features of the operations described below correspond to various embodiments described above. The exemplary methods shown in FIGS. 11-12 can be complementary to each other such that they can be used cooperatively to provide benefits, advantages, and/or solutions to problems described herein. Although the exemplary methods are illustrated in FIGS. 11-12 by specific blocks in particular orders, the operations corresponding to the blocks can be performed in different orders than shown and can be combined and/or divided into blocks having different functionality than shown. Optional blocks and/or operations are indicated by dashed lines.

More specifically, FIG. 11 illustrates an exemplary method (e.g., procedure) for a first node to manage rekeying of a security association (SA) between the first node and a second node in a communication network, according to various embodiments of the present disclosure. For example, the exemplary method shown in FIG. 11 can be performed by a node (e.g., host, gateway, UE, network node, server, etc.) described herein with reference to other figures.

The exemplary method can include the operations of block 1110, where the first node can send to the second node a request indicating a rekey priority of the first node. The exemplary method can also include the operations of block 1120, where the first node can receive from the second node a response indicating a rekey priority of the second node. The exemplary method can also include the operations of block 1130, where the first node can selectively initiate rekeying of the SA between the first node and the second node based on the request and the response.

In some embodiments, the request and the response comprise one of the following: an IKE_INIT exchange, an IKE_AUTH exchange (e.g., as in FIG. 4), or a CREATE_CHILD_SA exchange (e.g., as in FIG. 5). In some embodiments, the SA is one of the following: an IKE SA, or a child SA.

However, the SA is not required to be associated with and/or specific to IKE and/or IPSec. Instead, the SA can be associated with any protocol that uses keys to encrypt messages for secure exchange of data between nodes, with IPSec being just one example. Likewise, the request and the response are not IKE- or IPSec-specific but can be part of any exchange that facilitates rekeying for secure exchange of data between nodes.

In some embodiments, the request and the response include a message type field that can have any one of a plurality of different values, including a first message type value (e.g., “REKEY_PRI”) indicating that the sending node (e.g., first node sending request, second node sending response) supports rekey priority. In some of these embodiments, when the request includes a message type field that does not have the first message type value, the response also includes a message type field that does not have the first message type value. For example, the second node does not respond with a Notify payload having a “REKEY_PRI” message type if the first node sends a request without such a payload.

In some embodiments, when the request or the response includes a message type field having the first message type value, the request or the response also includes a rekey priority indicator that can have any one of a plurality of different values. For example, the rekey priority indicator can be the data field discussed above with respect to other figures.

In some embodiments, when present, the message type field and the rekey priority indicator are included in a Notify message, which is included in an encrypted payload of the request or the response (e.g., SK{ } discussed above).

In some embodiments, the plurality of different values of the rekey priority indicator include a plurality of first values that indicate a respective plurality of different rekey priorities configured in the sending node.

In some of these embodiments, the exemplary method can also include the operations of block 1105, where the first node can randomly select the rekey priority of the first node (i.e., its own rekey priority) based on determining that rekeying is enabled but rekey priority is not configured in the first node. In such case, the request (e.g., sent in block 1110) includes one of the first values that indicates the randomly selected rekey priority of the first node.

In some of these embodiments, when the request and the response include respective rekey priority indicators with any of the first values, selectively initiating the rekeying of the SA in block 1130 includes the operations of sub-blocks 1131-1132. In sub-block 1131, the first node can initiate the rekeying of the SA when the rekey priority of the first node is greater than or equal to the rekey priority of the second node. In sub-block 1132, the first node can refrain from initiating the rekeying of the SA when the rekey priority of the first node is less than the rekey priority of the second node. In some of these embodiments, the exemplary method can also include the operations of block 1140, where the first node can complete a rekeying of the SA that was initiated by the second node. This can be done, for example, when the request and the response include respective rekey priority indicators with any of the first values and the rekey priority of the first node is less than the rekey priority of the second node.

In some embodiments, the plurality of different values of the rekey priority indicator include a second value (e.g., zero) that indicates rekeying is disabled in the sending node. In some variants, the second value can be a particular one of the first values that also indicates a lowest rekey priority. In such embodiments, selectively initiating the rekeying of the SA in block 1130 can include the operations of block 1133, where the first node can initiate the rekeying of the SA when a rekey priority indicator having the second value is present in the response and rekeying is enabled in the first node.

In addition, FIG. 12 illustrates an exemplary method (e.g., procedure) for a second node to manage rekeying of a security association (SA) between the second node and a first node in a communication network, according to various embodiments of the present disclosure. For example, the exemplary method shown in FIG. 12 can be performed by a node (e.g., host, gateway, UE, network node, server, etc.) described herein with reference to other figures.

The exemplary method can include the operations of block 1210, where the second node can receive from the first node a request indicating a rekey priority of the first node. The exemplary method can also include the operations of block 1220, where the second node can send to the first node a response indicating a rekey priority of the second node. The exemplary method can also include the operation of block 1230, where the second node can selectively initiate rekeying of the SA between the first node and the second node based on the request and the response.

In some embodiments, the request and the response comprise one of the following: an IKE_INIT exchange, an IKE_AUTH exchange (e.g., as in FIG. 4), or a CREATE_CHILD_SA exchange (e.g., as in FIG. 5). In some embodiments, the SA is one of the following: an IKE SA, or a child SA.

However, the SA is not required to be associated with and/or specific to IKE and/or IPSec. Instead, the SA can be associated with any protocol that uses keys to encrypt messages for secure exchange of data between nodes, with IPSec being just one example. Likewise, the request and the response are not IKE- or IPSec-specific but can be part of any exchange that facilitates rekeying for secure exchange of data between nodes.

In some embodiments, the request and the response include a message type field that can have any one of a plurality of different values, including a first message type value (e.g., “REKEY_PRI”) indicating that the sending node (e.g., first node sending request, second node sending response) supports rekey priority. In some of these embodiments, when the request includes a message type field that does not have the first message type value, the response also includes a message type field that does not have the first message type value. For example, the second node does not respond with a Notify payload having a “REKEY_PRI” message type if the first node sends a request without such a payload.

In some embodiments, when the request or the response includes a message type field having the first message type value, the request or the response also includes a rekey priority indicator that can have any one of a plurality of different values. For example, the rekey priority indicator can be the data field discussed above with respect to other figures.

In some embodiments, when present, the message type field and the rekey priority indicator are included in a Notify message, which is included in an encrypted payload of the request or the response (e.g., SK{ } discussed above).

In some embodiments, the plurality of different values of the rekey priority indicator include a plurality of first values that indicate a respective plurality of different rekey priorities configured in the sending node.

In some of these embodiments, the exemplary method can also include the operations of block 1215, where the second node can randomly select the rekey priority of the second node (i.e., its own rekey priority) based on determining that rekeying is enabled but rekey priority is not configured in the second node. In such case, the response (e.g., sent in block 1220) includes one of the first values that indicates the randomly selected rekey priority of the second node.

In some of these embodiments, when the request and the response include respective rekey priority indicators with any of the first values, selectively initiating the rekeying of the SA in block 1230 includes the operations of sub-blocks 1231-1232. In sub-block 1231, the second node can initiate the rekeying of the SA when the rekey priority of the second node is greater than or equal to the rekey priority of the first node. In sub-block 1232, the second node can refrain from initiating the rekeying of the SA when the rekey priority of the second node is less than the rekey priority of the first node.

In some of these embodiments, the exemplary method can also include the operations of block 1240, where the second node can complete a rekeying of the SA that was initiated by the first node. This can be done, for example, when the request and the response include respective rekey priority indicators with any of the first values and the rekey priority of the second node is less than the rekey priority of the first node.

In some embodiments, the plurality of different values of the rekey priority indicator include a second value (e.g., zero) that indicates rekeying is disabled in the sending node. In some variants, the second value can be a particular one of the first values that also indicates a lowest rekey priority. In such embodiments, selectively initiating the rekeying of the SA in block 1230 can include the operations of block 1233, where the second node can initiate the rekeying of the SA when a rekey priority indicator having the second value is present in the request and rekeying is enabled in the second node.

FIG. 13 shows an exemplary communication network (1300) in which various procedures described above can be implemented. The exemplary communication network includes two endpoint nodes (1310, 1340) and two gateway nodes (1320, 1330) between the endpoint nodes. These nodes can communicate with each other via wired or wireless connections, or a combination thereof, using compatible protocols (e.g., TCP/IP, IPSec, etc.). Any of the nodes 1310-1340 can be a first node that performs associated procedures described above in relation to various embodiments, and any other of the nodes 1310-1340 can be a second node that performs procedures described above in relation to various embodiments. More specifically, the procedures described above can be implemented based on any of the following SAs:
(1351) between endpoint node 1310 and gateway node 1320;
(1352) between endpoint node 1340 and gateway node 1330;
(1353) between gateway node 1320 and gateway node 1330;
(1354) between endpoint node 1310 and gateway node 1330;
(1355) between endpoint node 1340 and gateway node 1320; and
(1356) between endpoint node 1310 and endpoint node 1340.

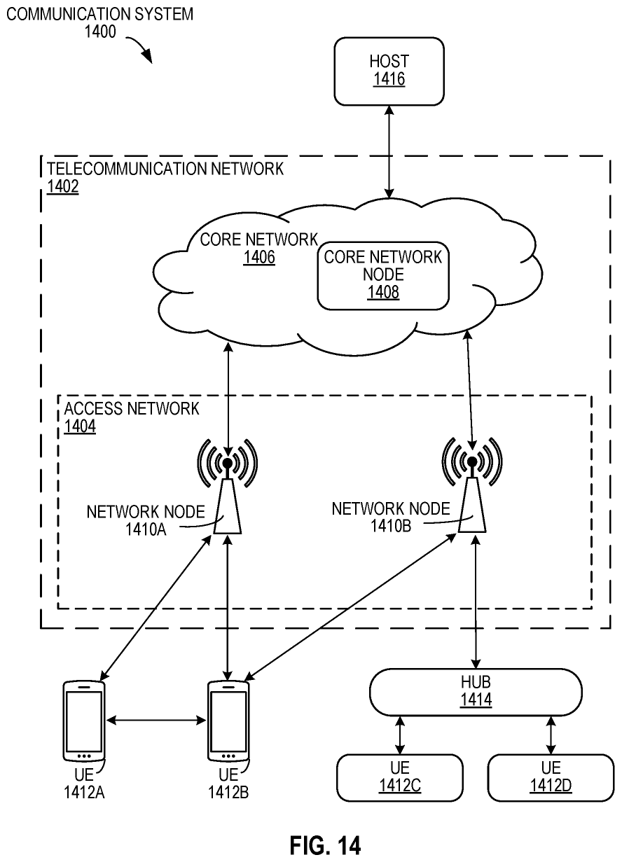

FIG. 14 shows an example of a communication system 1400 in which various embodiments of the present disclosure can be implemented. In this example, the communication system 1400 includes a telecommunication network 1402 that includes an access network 1404, such as a radio access network (RAN), and a core network 1406, which includes one or more core network nodes 1408. The access network 1404 includes one or more access network nodes, such as network nodes 1410a and 1410b (one or more of which may be generally referred to as network nodes 1410), or any other similar 3^{rd} Generation Partnership Project (3GPP) access node or non-3GPP access point. The network nodes 1410 facilitate direct or indirect connection of user equipment (UE), such as by connecting UEs 1412a, 1412b, 1412c, and 1412d (one or more of which may be generally referred to as UEs 1412) to the core network 1406 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1400 may include any number of wired or wireless networks, network nodes, UEs, and/or any other components or systems that may facilitate or participate in the communication of data and/or signals whether via wired or wireless connections. The communication system 1400 may include and/or interface with any type of communication, telecommunication, data, cellular, radio network, and/or other similar type of system.

The UEs 1412 may be any of a wide variety of communication devices, including wireless devices arranged, configured, and/or operable to communicate wirelessly with the network nodes 1410 and other communication devices. Similarly, the network nodes 1410 are arranged, capable, configured, and/or operable to communicate directly or indirectly with the UEs 1412 and/or with other network nodes or equipment in the telecommunication network 1402 to enable and/or provide network access, such as wireless network access, and/or to perform other functions, such as administration in the telecommunication network 1402.

In the depicted example, the core network 1406 connects the network nodes 1410 to one or more hosts, such as host 1416. These connections may be direct or indirect via one or more intermediary networks or devices. In other examples, network nodes may be directly coupled to hosts. The core network 1406 includes one more core network nodes (e.g., core network node 1408) that are structured with hardware and software components. Features of these components may be substantially similar to those described with respect to the UEs, network nodes, and/or hosts, such that the descriptions thereof are generally applicable to the corresponding components of the core network node 1408. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 1416 may be under the ownership or control of a service provider other than an operator or provider of the access network 1404 and/or the telecommunication network 1402, and may be operated by the service provider or on behalf of the service provider. The host 1416 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1400 of FIG. 14 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 1402 is a cellular network that implements 3GPP standardized features. Accordingly, the telecommunications network 1402 may support network slicing to provide different logical networks to different devices that are connected to the telecommunication network 1402. For example, the telecommunications network 1402 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 1412 are configured to transmit and/or receive information without direct human interaction. For instance, a UE may be designed to transmit information to the access network 1404 on a predetermined schedule, when triggered by an internal or external event, or in response to requests from the access network 1404. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, the hub 1414 communicates with the access network 1404 to facilitate indirect communication between one or more UEs (e.g., UE 1412c and/or 1412d) and network nodes (e.g., network node 1410b). In some examples, the hub 1414 may be a controller, router, content source and analytics, or any of the other communication devices described herein regarding UEs. For example, the hub 1414 may be a broadband router enabling access to the core network 1406 for the UEs. As another example, the hub 1414 may be a controller that sends commands or instructions to one or more actuators in the UEs. Commands or instructions may be received from the UEs, network nodes 1410, or by executable code, script, process, or other instructions in the hub 1414. As another example, the hub 1414 may be a data collector that acts as temporary storage for UE data and, in some embodiments, may perform analysis or other processing of the data. As another example, the hub 1414 may be a content source. For example, for a UE that is a VR headset, display, loudspeaker or other media delivery device, the hub 1414 may retrieve VR assets, video, audio, or other media or data related to sensory information via a network node, which the hub 1414 then provides to the UE either directly, after performing local processing, and/or after adding additional local content. In still another example, the hub 1414 acts as a proxy server or orchestrator for the UEs, in particular in if one or more of the UEs are low energy IoT devices.

The hub 1414 may have a constant/persistent or intermittent connection to the network node 1410b. The hub 1414 may also allow for a different communication scheme and/or schedule between the hub 1414 and UEs (e.g., UE 1412c and/or 1412d), and between the hub 1414 and the core network 1406. In other examples, the hub 1414 is connected to the core network 1406 and/or one or more UEs via a wired connection. Moreover, the hub 1414 may be configured to connect to an M2M service provider over the access network 1404 and/or to another UE over a direct connection. In some scenarios, UEs may establish a wireless connection with the network nodes 1410 while still connected via the hub 1414 via a wired or wireless connection. In some embodiments, the hub 1414 may be a dedicated hub—that is, a hub whose primary function is to route communications to/from the UEs from/to the network node 1410b. In other embodiments, the hub 1414 may be a non-dedicated hub—that is, a device which is capable of operating to route communications between the UEs and network node 1410b, but which is additionally capable of operating as a communication start and/or end point for certain data channels.

Any of the UE 1412, network node 1410, core network node 1408, and host 1416 shown in FIG. 14 can be a first node that performs associated procedures described above in relation to various embodiments, and any other of the nodes shown in FIG. 14 can be a second node that performs procedures described above in relation to various embodiments. As non-limiting examples, the procedures described above can be implemented based on any of the following SAs:
between a UE 1412 and host 1416;
between a UE 1412 and another UE 1412;
between a UE 1412 and a core network node 1408; and
between host 1416 and a core network node 1408.

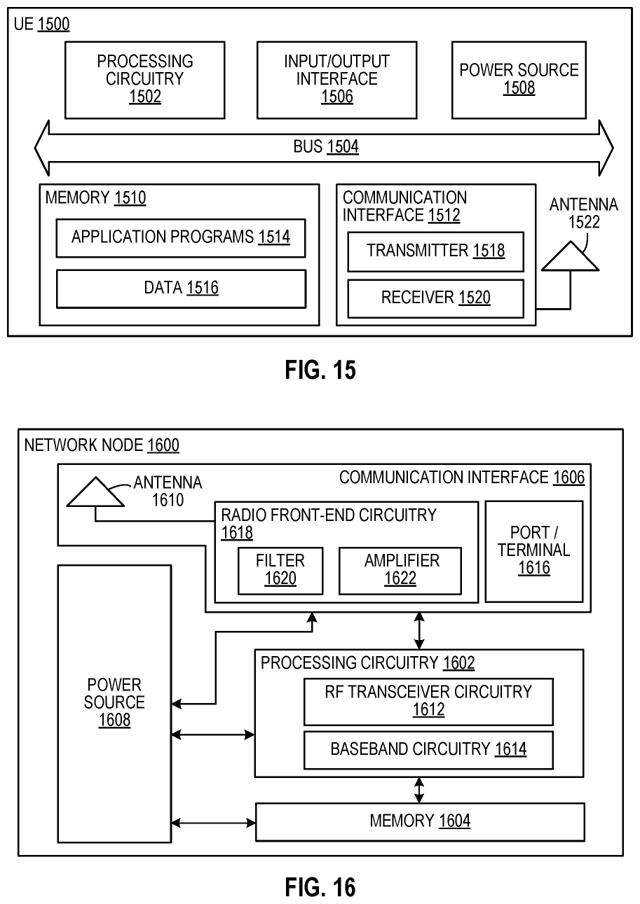

FIG. 15 shows a UE 1500 in accordance with some embodiments. As used herein, a UE refers to a device capable, configured, arranged and/or operable to communicate (e.g., wirelessly and/or via wire) with network nodes and/or other UEs. Examples of a UE include, but are not limited to, a smart phone, mobile phone, cell phone, voice over IP (VOIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1500 includes processing circuitry 1502 that is operatively coupled via a bus 1504 to an input/output interface 1506, a power source 1508, a memory 1510, a communication interface 1512, and/or any other component, or any combination thereof. Certain UEs may utilize all or a subset of the components shown in FIG. 15. The level of integration between the components may vary from one UE to another UE. Further, certain UEs may contain multiple instances of a component, such as multiple processors, memories, transceivers, transmitters, receivers, etc.

The processing circuitry 1502 is configured to process instructions and data and may be configured to implement any sequential state machine operative to execute instructions stored as machine-readable computer programs in the memory 1510. The processing circuitry 1502 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 1502 may include multiple central processing units (CPUs).

In the example, the input/output interface 1506 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1500. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1508 is structured as a battery or battery pack. Other types of power sources, such as an external power source (e.g., an electricity outlet), photovoltaic device, or power cell, may be used. The power source 1508 may further include power circuitry for delivering power from the power source 1508 itself, and/or an external power source, to the various parts of the UE 1500 via input circuitry or an interface such as an electrical power cable. Delivering power may be, for example, for charging of the power source 1508. Power circuitry may perform any formatting, converting, or other modification to the power from the power source 1508 to make the power suitable for the respective components of the UE 1500 to which power is supplied.

The memory 1510 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 1510 includes one or more application programs 1514, such as an operating system, web browser application, a widget, gadget engine, or other application, and corresponding data 1516. The memory 1510 may store, for use by the UE 1500, any of a variety of various operating systems or combinations of operating systems.

The memory 1510 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 1510 may allow the UE 1500 to access instructions, application programs and the like, stored on transitory or non-transitory memory media, to off-load data, or to upload data. An article of manufacture, such as one utilizing a communication system may be tangibly embodied as or in the memory 1510, which may be or comprise a device-readable storage medium.

The processing circuitry 1502 may be configured to communicate with an access network or other network using the communication interface 1512. The communication interface 1512 may comprise one or more communication subsystems and may include or be communicatively coupled to an antenna 1522. The communication interface 1512 may include one or more transceivers used to communicate, such as by communicating with one or more remote transceivers of another device capable of wireless communication (e.g., another UE or a network node in an access network). Each transceiver may include a transmitter 1518 and/or a receiver 1520 appropriate to provide network communications (e.g., optical, electrical, frequency allocations, and so forth). Moreover, the transmitter 1518 and receiver 1520 may be coupled to one or more antennas (e.g., antenna 1522) and may share circuit components, software or firmware, or alternatively be implemented separately.

In the illustrated embodiment, communication functions of the communication interface 1512 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1512, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1500 shown in FIG. 15.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

UE 1500 can be a first node that performs associated procedures described above in relation to various embodiments. UE 1500 can also be a second node that performs procedures described above in relation to various embodiments.

FIG. 16 shows a network node 1600 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1600 includes a processing circuitry 1602, a memory 1604, a communication interface 1606, and a power source 1608. The network node 1600 may be composed of multiple physically separate components (e.g., a NodeB component and a RNC component, or a BTS component and a BSC component, etc.), which may each have their own respective components. In certain scenarios in which the network node 1600 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 1600 may be configured to support multiple radio access technologies (RATs). In such embodiments, some components may be duplicated (e.g., separate memory 1604 for different RATs) and some components may be reused (e.g., a same antenna 1610 may be shared by different RATs). The network node 1600 may also include multiple sets of the various illustrated components for different wireless technologies integrated into network node 1600, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1600.

The processing circuitry 1602 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1600 components, such as the memory 1604, to provide network node 1600 functionality.

In some embodiments, the processing circuitry 1602 includes a system on a chip (SOC). In some embodiments, the processing circuitry 1602 includes one or more of radio frequency (RF) transceiver circuitry 1612 and baseband processing circuitry 1614. In some embodiments, the radio frequency (RF) transceiver circuitry 1612 and the baseband processing circuitry 1614 may be on separate chips (or sets of chips), boards, or units, such as radio units and digital units. In alternative embodiments, part or all of RF transceiver circuitry 1612 and baseband processing circuitry 1614 may be on the same chip or set of chips, boards, or units.

The memory 1604 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 1602. The memory 1604 may store any suitable instructions, data, or information, including a computer program, software, an application including one or more of logic, rules, code, tables, and/or other instructions capable of being executed by the processing circuitry 1602 and utilized by the network node 1600. The memory 1604 may be used to store any calculations made by the processing circuitry 1602 and/or any data received via the communication interface 1606. In some embodiments, the processing circuitry 1602 and memory 1604 is integrated.

The communication interface 1606 is used in wired or wireless communication of signaling and/or data between a network node, access network, and/or UE. As illustrated, the communication interface 1606 comprises port(s)/terminal(s) 1616 to send and receive data, for example to and from a network over a wired connection. The communication interface 1606 also includes radio front-end circuitry 1618 that may be coupled to, or in certain embodiments a part of, the antenna 1610. Radio front-end circuitry 1618 comprises filters 1620 and amplifiers 1622. The radio front-end circuitry 1618 may be connected to an antenna 1610 and processing circuitry 1602. The radio front-end circuitry may be configured to condition signals communicated between antenna 1610 and processing circuitry 1602. The radio front-end circuitry 1618 may receive digital data that is to be sent out to other network nodes or UEs via a wireless connection. The radio front-end circuitry 1618 may convert the digital data into a radio signal having the appropriate channel and bandwidth parameters using a combination of filters 1620 and/or amplifiers 1622. The radio signal may then be transmitted via the antenna 1610. Similarly, when receiving data, the antenna 1610 may collect radio signals which are then converted into digital data by the radio front-end circuitry 1618. The digital data may be passed to the processing circuitry 1602. In other embodiments, the communication interface may comprise different components and/or different combinations of components.

In certain alternative embodiments, the network node 1600 does not include separate radio front-end circuitry 1618, instead, the processing circuitry 1602 includes radio front-end circuitry and is connected to the antenna 1610. Similarly, in some embodiments, all or some of the RF transceiver circuitry 1612 is part of the communication interface 1606. In still other embodiments, the communication interface 1606 includes one or more ports or terminals 1616, the radio front-end circuitry 1618, and the RF transceiver circuitry 1612, as part of a radio unit (not shown), and the communication interface 1606 communicates with the baseband processing circuitry 1614, which is part of a digital unit (not shown).

The antenna 1610 may include one or more antennas, or antenna arrays, configured to send and/or receive wireless signals. The antenna 1610 may be coupled to the radio front-end circuitry 1618 and may be any type of antenna capable of transmitting and receiving data and/or signals wirelessly. In certain embodiments, the antenna 1610 is separate from the network node 1600 and connectable to the network node 1600 through an interface or port.

The antenna 1610, communication interface 1606, and/or the processing circuitry 1602 may be configured to perform any receiving operations and/or certain obtaining operations described herein as being performed by the network node. Any information, data and/or signals may be received from a UE, another network node and/or any other network equipment. Similarly, the antenna 1610, the communication interface 1606, and/or the processing circuitry 1602 may be configured to perform any transmitting operations described herein as being performed by the network node. Any information, data and/or signals may be transmitted to a UE, another network node and/or any other network equipment.

The power source 1608 provides power to the various components of network node 1600 in a form suitable for the respective components (e.g., at a voltage and current level needed for each respective component). The power source 1608 may further comprise, or be coupled to, power management circuitry to supply the components of the network node 1600 with power for performing the functionality described herein. For example, the network node 1600 may be connectable to an external power source (e.g., the power grid, an electricity outlet) via an input circuitry or interface such as an electrical cable, whereby the external power source supplies power to power circuitry of the power source 1608. As a further example, the power source 1608 may comprise a source of power in the form of a battery or battery pack which is connected to, or integrated in, power circuitry. The battery may provide backup power should the external power source fail.

Embodiments of the network node 1600 may include additional components beyond those shown in FIG. 16 for providing certain aspects of the network node's functionality, including any of the functionality described herein and/or any functionality necessary to support the subject matter described herein. For example, the network node 1600 may include user interface equipment to allow input of information into the network node 1600 and to allow output of information from the network node 1600. This may allow a user to perform diagnostic, maintenance, repair, and other administrative functions for the network node 1600.

Network node 1600 can be a first node that performs associated procedures described above in relation to various embodiments. Network node 1600 can also be a second node that performs procedures described above in relation to various embodiments.

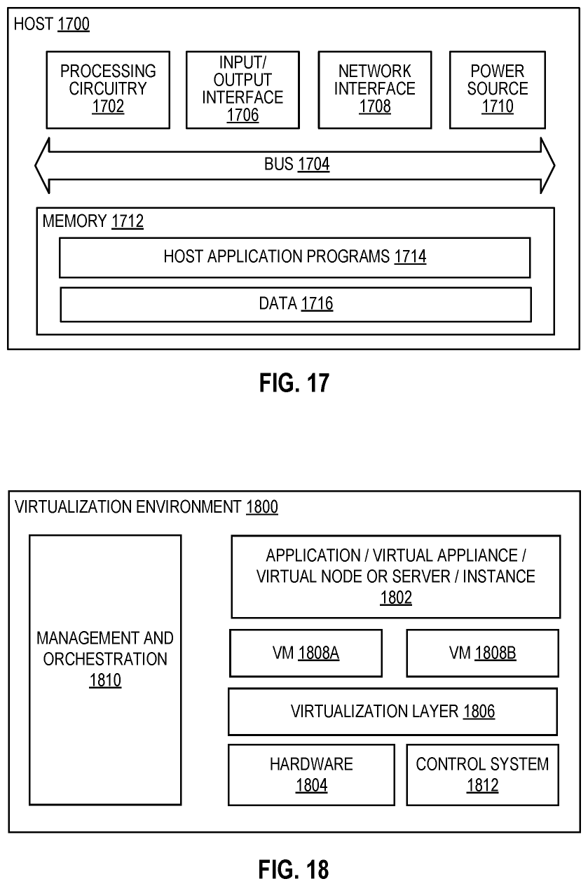

FIG. 17 is a block diagram of a host 1700, which may be an embodiment of the host 1416 of FIG. 14, in accordance with various aspects described herein. As used herein, the host 1700 may be or comprise various combinations hardware and/or software, including a standalone server, a blade server, a cloud-implemented server, a distributed server, a virtual machine, container, or processing resources in a server farm. The host 1700 may provide one or more services to one or more UEs.

The host 1700 includes processing circuitry 1702 that is operatively coupled via a bus 1704 to an input/output interface 1706, a network interface 1708, a power source 1710, and a memory 1712. Other components may be included in other embodiments. Features of these components may be substantially similar to those described with respect to the devices of previous figures, such as FIGS. 15 and 16, such that the descriptions thereof are generally applicable to the corresponding components of host 1700.

The memory 1712 may include one or more computer programs including one or more host application programs 1714 and data 1716, which may include user data, e.g., data generated by a UE for the host 1700 or data generated by the host 1700 for a UE. Embodiments of the host 1700 may utilize only a subset or all of the components shown. The host application programs 1714 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1714 may also provide for user authentication and licensing checks and may periodically report health, routes, and content availability to a central node, such as a device in or on the edge of a core network. Accordingly, the host 1700 may select and/or indicate a different host for over-the-top services for a UE. The host application programs 1714 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

Host 1700 can be a first node that performs associated procedures described above in relation to various embodiments. Host 1700 can also be a second node that performs procedures described above in relation to various embodiments.

FIG. 18 is a block diagram illustrating a virtualization environment 1800 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1800 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1802 (which may alternatively be called software instances, virtual appliances, network functions, virtual nodes, virtual network functions, etc.) are run in the virtualization environment 1800 to implement some of the features, functions, and/or benefits of some of the embodiments disclosed herein.

Hardware 1804 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1806 (also referred to as hypervisors or virtual machine monitors (VMMs)), provide VMs 1808a and 1808b (one or more of which may be generally referred to as VMs 1808), and/or perform any of the functions, features and/or benefits described in relation with some embodiments described herein. The virtualization layer 1806 may present a virtual operating platform that appears like networking hardware to the VMs 1808.

The VMs 1808 comprise virtual processing, virtual memory, virtual networking or interface and virtual storage, and may be run by a corresponding virtualization layer 1806. Different embodiments of the instance of a virtual appliance 1802 may be implemented on one or more of VMs 1808, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1808 may be a software implementation of a physical machine that runs programs as if they were executing on a physical, non-virtualized machine. Each of the VMs 1808, and that part of hardware 1804 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1808 on top of the hardware 1804 and corresponds to the application 1802.

Hardware 1804 may be implemented in a standalone network node with generic or specific components. Hardware 1804 may implement some functions via virtualization. Alternatively, hardware 1804 may be part of a larger cluster of hardware (e.g., such as in a data center or CPE) where many hardware nodes work together and are managed via management and orchestration 1810, which, among others, oversees lifecycle management of applications 1802. In some embodiments, hardware 1804 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1812 which may alternatively be used for communication between hardware nodes and radio units.

One or more of the applications 1802 (e.g., software instances, virtual appliances, network functions, virtual nodes, virtual network functions, etc.) hosted by virtualization environment 1800 can perform procedures described above in relation a first node. Likewise, one or more of the applications 1802 hosted by virtualization environment 1800 can perform procedures described above in relation a second node.

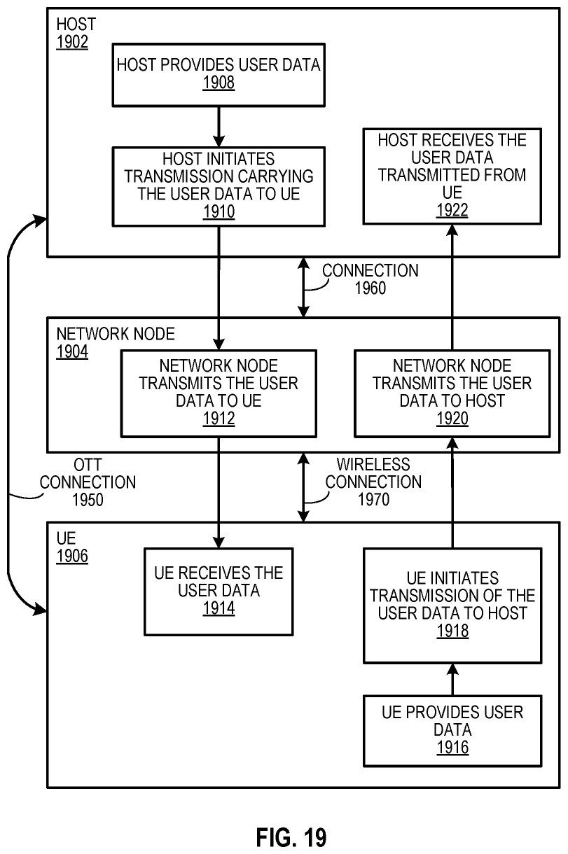

FIG. 19 shows a communication diagram of a host 1902 communicating via a network node 1904 with a UE 1906 over a partially wireless connection in accordance with some embodiments. Example implementations, in accordance with various embodiments, of the UE (such as a UE 1412a of FIG. 14 and/or UE 1500 of FIG. 15), network node (such as network node 1410a of FIG. 14 and/or network node 1600 of FIG. 16), and host (such as host 1416 of FIG. 14 and/or host 1700 of FIG. 17) discussed in the preceding paragraphs will now be described with reference to FIG. 19.

Like host 1700, embodiments of host 1902 include hardware, such as a communication interface, processing circuitry, and memory. The host 1902 also includes software, which is stored in or accessible by the host 1902 and executable by the processing circuitry. The software includes a host application that may be operable to provide a service to a remote user, such as the UE 1906 connecting via an over-the-top (OTT) connection 1950 extending between the UE 1906 and host 1902. In providing the service to the remote user, a host application may provide user data which is transmitted using the OTT connection 1950.

The network node 1904 includes hardware enabling it to communicate with the host 1902 and UE 1906. The connection 1960 may be direct or pass through a core network (like core network 1406 of FIG. 14) and/or one or more other intermediate networks, such as one or more public, private, or hosted networks. For example, an intermediate network may be a backbone network or the Internet.

The UE 1906 includes hardware and software, which is stored in or accessible by UE 1906 and executable by the UE's processing circuitry. The software includes a client application, such as a web browser or operator-specific “app” that may be operable to provide a service to a human or non-human user via UE 1906 with the support of the host 1902. In the host 1902, an executing host application may communicate with the executing client application via the OTT connection 1950 terminating at the UE 1906 and host 1902. In providing the service to the user, the UE's client application may receive request data from the host's host application and provide user data in response to the request data. The OTT connection 1950 may transfer both the request data and the user data. The UE's client application may interact with the user to generate the user data that it provides to the host application through the OTT connection 1950.

The OTT connection 1950 may extend via a connection 1960 between the host 1902 and the network node 1904 and via a wireless connection 1970 between the network node 1904 and the UE 1906 to provide the connection between the host 1902 and the UE 1906. The connection 1960 and wireless connection 1970, over which the OTT connection 1950 may be provided, have been drawn abstractly to illustrate the communication between the host 1902 and the UE 1906 via the network node 1904, without explicit reference to any intermediary devices and the precise routing of messages via these devices.

As an example of transmitting data via the OTT connection 1950, in step 1908, the host 1902 provides user data, which may be performed by executing a host application. In some embodiments, the user data is associated with a particular human user interacting with the UE 1906. In other embodiments, the user data is associated with a UE 1906 that shares data with the host 1902 without explicit human interaction. In step 1910, the host 1902 initiates a transmission carrying the user data towards the UE 1906. The host 1902 may initiate the transmission responsive to a request transmitted by the UE 1906. The request may be caused by human interaction with the UE 1906 or by operation of the client application executing on the UE 1906. The transmission may pass via the network node 1904, in accordance with the teachings of the embodiments described throughout this disclosure. Accordingly, in step 1912, the network node 1904 transmits to the UE 1906 the user data that was carried in the transmission that the host 1902 initiated, in accordance with the teachings of the embodiments described throughout this disclosure. In step 1914, the UE 1906 receives the user data carried in the transmission, which may be performed by a client application executed on the UE 1906 associated with the host application executed by the host 1902.

In some examples, the UE 1906 executes a client application which provides user data to the host 1902. The user data may be provided in reaction or response to the data received from the host 1902. Accordingly, in step 1916, the UE 1906 may provide user data, which may be performed by executing the client application. In providing the user data, the client application may further consider user input received from the user via an input/output interface of the UE 1906. Regardless of the specific manner in which the user data was provided, the UE 1906 initiates, in step 1918, transmission of the user data towards the host 1902 via the network node 1904. In step 1920, in accordance with the teachings of the embodiments described throughout this disclosure, the network node 1904 receives user data from the UE 1906 and initiates transmission of the received user data towards the host 1902. In step 1922, the host 1902 receives the user data carried in the transmission initiated by the UE 1906.

Any of UE 1906, network node 1904, and host 1902 shown in FIG. 19 can be a first node that performs associated procedures described above in relation to various embodiments, and any other of UE 1906, network node 1904, and host 1902 can be a second node that performs procedures described above in relation to various embodiments.

Embodiments described herein can improve OTT services provided to the UE 1906 using the OTT connection 1950, in which the wireless connection 1970 forms the last segment. For example, embodiments described herein can restrict rekeying to be initiated by only one of two nodes that share a SA (e.g., in IPSec communications). As such, embodiments can reduce, minimize, or even eliminate the problems associated with redundant SAs, thereby avoiding the negative impacts to node resources (e.g., processing, memory, communication, etc.) as well as communication resources (e.g., transmission, routing, etc.) between nodes. At a higher level, embodiments facilitate secure communication between two nodes based on maintaining up-to-date SAs without excess use of available resources. In this manner, embodiments can improve security of OTT services (e.g., based on SAs between UE 1906 and host 1092), thereby increasing the value of such services to end users and service providers.

In an example scenario, factory status information may be collected and analyzed by the host 1902. As another example, the host 1902 may process audio and video data which may have been retrieved from a UE for use in creating maps. As another example, the host 1902 may collect and analyze real-time data to assist in controlling vehicle congestion (e.g., controlling traffic lights). As another example, the host 1902 may store surveillance video uploaded by a UE. As another example, the host 1902 may store or control access to media content such as video, audio, VR or AR which it can broadcast, multicast or unicast to UEs. As other examples, the host 1902 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1950 between the host 1902 and UE 1906, in response to variations in the measurement results. The measurement procedure and/or the network functionality for reconfiguring the OTT connection may be implemented in software and hardware of the host 1902 and/or UE 1906. In some embodiments, sensors (not shown) may be deployed in or in association with other devices through which the OTT connection 1950 passes; the sensors may participate in the measurement procedure by supplying values of the monitored quantities exemplified above, or supplying values of other physical quantities from which software may compute or estimate the monitored quantities. The reconfiguring of the OTT connection 1950 may include message format, retransmission settings, preferred routing etc.; the reconfiguring need not directly alter the operation of the network node 1904. Such procedures and functionalities may be known and practiced in the art. In certain embodiments, measurements may involve proprietary UE signaling that facilitates measurements of throughput, propagation times, latency and the like, by the host 1902. The measurements may be implemented in that software causes messages to be transmitted, in particular empty or ‘dummy’ messages, using the OTT connection 1950 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various exemplary embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously. Further, to the extent that the prior art knowledge has not been explicitly incorporated by reference herein above, it is explicitly incorporated herein in its entirety. All publications referenced are incorporated herein by reference in their entireties.

1.-38. (canceled)

39. A method performed by a first node to manage rekeying of a security association (SA) between the first node and a second node in a communication network, the method comprising:
sending to the second node a request indicating a rekey priority of the first node;
receiving from the second node a response indicating a rekey priority of the second node; and
selectively initiating rekeying of the SA between the first node and the second node based on the request and the response.

40. The method of claim 39, wherein the request and the response include a message type field that can have any one of a plurality of different values, including a first message type value indicating that the sending node supports rekey priority.

41. The method of claim 40, wherein when the request includes a message type field that does not have the first message type value, the response also includes a message type field that does not have the first message type value.

42. The method of claim 40, wherein when the request or the response includes a message type field having the first message type value, the request or the response also includes a rekey priority indicator that can have any one of a plurality of different values.

43. The method of claim 42, wherein:
when present, the message type field and the rekey priority indicator are included in a Notify message; and
the Notify message is included in an encrypted payload of the request or the response.

44. The method of claim 42, wherein the plurality of different values of the rekey priority indicator include a plurality of first values that indicate a respective plurality of different rekey priorities configured in the sending node.

45. The method of claim 44, wherein:
the method further comprises randomly selecting the rekey priority of the first node based on determining that rekeying is enabled but rekey priority is not configured in the first node; and
the request includes one of the first values that indicates the randomly selected rekey priority of the first node.

46. The method of claim 44, wherein selectively initiating the rekeying of the SA comprises, when the request and the response include respective rekey priority indicators with any of the first values:
initiating the rekeying of the SA when the rekey priority of the first node is greater than or equal to the rekey priority of the second node; and
refraining from initiating the rekeying of the SA when the rekey priority of the first node is less than the rekey priority of the second node.

47. The method of claim 46, further comprising, when the request and the response include respective rekey priority indicators with any of the first values and the rekey priority of the first node is less than the rekey priority of the second node, completing a rekeying of the SA that was initiated by the second node.

48. The method of claim 44, wherein:
the plurality of different values of the rekey priority indicator include a second value that indicates rekeying is disabled in the sending node; and
selectively initiating the rekeying of the SA comprises initiating the rekeying of the SA when a rekey priority indicator having the second value is present in the response and rekeying is enabled in the first node.

49. The method of claim 48, wherein the second value is a particular one of the first values that also indicates a lowest rekey priority.

50. The method of claim 39, wherein the request and the response comprise one of the following: an IKE_INIT exchange, an IKE_AUTH exchange, or a CREATE_CHILD_SA exchange.

51. A method performed by a second node to manage rekeying of a security association (SA) between the second node and a first node in a communication network, the method comprising:
receiving from the first node a request indicating a rekey priority of the first node;
sending to the first node a response indicating a rekey priority of the second node; and
selectively initiating rekeying of the SA between the first node and the second node based on the request and the response.

52. The method of claim 51, wherein the request and the response include a message type field that can have any one of a plurality of different values, including a first message type value indicating that the sending node supports rekey priority.

53. The method of claim 52, wherein when the request includes a message type field that does not have the first message type value, the response also includes a message type field that does not have the first message type value.

54. The method of claim 52, wherein when the request or the response includes a message type field having the first message type value, the request or the response also includes a rekey priority indicator that can have any one of a plurality of different values.

55. The method of claim 54, wherein:
when present, the message type field and the rekey priority indicator are included in a Notify message; and
the Notify message is included in an encrypted payload of the request or the response.

56. The method of claim 54, wherein the plurality of different values of the rekey priority indicator include a plurality of first values that indicate a respective plurality of different rekey priorities configured in the sending node.

57. The method of claim 56, wherein:
the method further comprises randomly selecting the rekey priority of the second node based on determining that rekeying is enabled but rekey priority is not configured in the second node; and
the response includes one of the first values that indicates the randomly selected rekey priority of the second node.

58. The method of claim 56, wherein selectively initiating the rekeying of the SA comprises, when the request and the response include respective rekey priority indicators with any of the first values:
initiating the rekeying of the SA when the rekey priority of the second node is greater than or equal to the rekey priority of the first node; and
refraining from initiating the rekeying of the SA when the rekey priority of the second node is less than the rekey priority of the first node.

59. The method of claim 58, further comprising, when the request and the response include respective rekey priority indicators with any of the first values and the rekey priority of the second node is less than the rekey priority of the first node, completing a rekeying of the SA that was initiated by the first node.

60. The method of claim 57, wherein:
the plurality of different values of the rekey priority indicator include a second value that indicates rekeying is disabled in the sending node; and
selectively initiating the rekeying of the SA comprises initiating the rekeying of the SA when a rekey priority indicator having the second value is present in the request and rekeying is enabled in the second node.

61. The method of claim 60, wherein the second value is a particular one of the first values that also indicates a lowest rekey priority.

62. The method of claim 51, wherein the request and the response comprise one of the following: an IKE_INIT exchange, an IKE_AUTH exchange, or a CREATE_CHILD_SA exchange.

63. A first node configured to manage rekeying of a security association (SA) between the first node and a second node in a communication network, the first node comprising:
communication interface circuitry arranged for secure communication with the second node; and
processing circuitry operatively coupled to the communication interface circuitry, whereby the processing circuitry and the communication interface circuitry are configured to:
send to the second node a request indicating a rekey priority of the first node;
receive from the second node a response indicating a rekey priority of the second node; and
selectively initiate rekeying of the SA between the first node and the second node based on the request and the response.

64. A second node configured to manage rekeying of a security association (SA) between the second node and a first node in a communication network, the second node comprising:
communication interface circuitry arranged for secure communication with the first node; and
processing circuitry operatively coupled to the communication interface circuitry, whereby the processing circuitry and the communication interface circuitry are configured to perform the method of claim 51.
